(19) United States
(12) Patent Application Publication
(10) Pub. No.: US 2021/0350304 A1
(43) Pub. Date: Nov. 11, 2021

(54) AIDING FURTHER EXAMINATION OF A DATA SET FOR IMPROVING A CORRESPONDING KEY PERFORMANCE INDICATOR (KPI)

(71) Applicant: Oracle International Corporation, Redwood Shores, CA (US)

(72) Inventors: Tanmoy Bhowmik, Bangalore (IN); Anand Kumar Singh, Hyderabad (IN); Anirban Majumdar, Hyderabad (IN)

(21) Appl. No.: 16/946,383

(22) Filed: Jun. 19, 2020

(30) Foreign Application Priority Data
May 7, 2020 (IN) 202041019411

(51) Int. Cl. G06Q 10/06; G06Q 30/02

(52) U.S. Cl. CPC G06Q 10/06393; G06Q 30/0201

(57) ABSTRACT

An aspect of the present disclosure aids further examination of data set for improving corresponding key performance indicators (KPI). In an embodiment, a data set containing a plurality of data points is selected, with each data point specifying an individual fact value for a respective combination of members and each member being associated with a corresponding dimension. A respective aggregate fact value is generated for each member of each dimension. A respective variation among aggregate fact values of corresponding members is computed for each dimension. The set of dimensions having more variation is identified as containing pertinent information for further examination of a key performance indicator (KPI).

### PRIORITY CLAIM

The instant patent application is related to and claims priority from co-pending India Application entitled, “AIDING FURTHER EXAMINATION OF A DATA SET FOR IMPROVING A CORRESPONDING KEY PERFORMANCE INDICATOR (KPI)”, Application Number: 202041019411, filed on: 7 May 2020, First Named Inventor: Tanmoy Bhowmik, which is incorporated in its entirety herewith.

### RELATED APPLICATION

The instant application is related to co-pending India Patent Application No: UNASSIGNED, Entitled, “NOTIFYING KEY PERFORMANCE INDICATORS OF INTEREST IN A BUSINESS INTELLIGENCE SYSTEM”, inventors Tanmoy Bhowmik, Anand Kumar Singh and Anirban Majumdar, Filed: On even date herewith; Attorney Docket No: ORCL-235-US, which is incorporated in its entirety herewith.

### BACKGROUND OF THE DISCLOSURE

### Technical Field

The present disclosure relates to key performance indicators (KPIs) and more specifically to aiding further examination of a data set with respect to dimensions for improving a corresponding KPI.

### Related Art

A data set refers to a collection of data points. Organizations such as business firms, scientific establishments, academic institutes, etc., may collect large number of data points as a part of one or more data sets as part of their day-to-day operations. For example, a business firm may keep track of its quantum of product sales, an academic institute may keep track of number of admissions, etc. The data sets can be organized using any combination of relational, hierarchical, network, etc., type models as is well known in the relevant arts.

A key performance indicator (KPI) refers to a measure of an aspect of interest that can be determined by analysis of a corresponding data set. For example, KPIs relevant to a business firm may be aggregate sales quantum, employee turnover, etc. Similarly, for an academic institution, the relevant KPIs may be student attendance rate, grades of students, faculty retention rate, etc.

It is generally understood that critical examination of a KPI can be a basis for actionable items such as decision-making, resource planning, and evaluation of risks, etc., with the broader goal of improving the KPI. For example, a sales executive may examine the data with a view to improving aggregate sales, while an academic administrator may seek to enhance grades of students.

However, there are often numerous ways in which the same data set available for a specific KPI can be analyzed, with each way potentially providing a different degree of useful information. The large number of ways of analyzing a data set or presentation of related information can overwhelm a recipient (e.g., the sales executive) of the information.

Aspects of the present disclosure are directed to aiding further examination of a data set for improving a corresponding KPI.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which further examination of a data set for improving a corresponding KPI is aided according to an aspect of the present disclosure.

FIG. 3A depicts sample country dimension table in an embodiment.

FIG. 3B depicts sample store dimension table in an embodiment.

FIG. 3C depicts sample product dimension table in an embodiment.

FIG. 3D depicts sample fact table of sales for the year 2016 in an embodiment.

FIG. 4A depicts aggregate fact table generated for the country dimension for the KPI “total sales” in an embodiment.

FIG. 4B depicts aggregate fact table generated for the store dimension for the KPI “total sales” in an embodiment.

FIG. 4C depicts aggregate fact table generated for the product dimension for the KPI “total sales” in an embodiment.

FIG. 5A depicts sample fact table of sales for the year 2017 in an embodiment.

FIG. 5B depicts aggregate fact table generated for the country dimension for the KPI “percentage of sales growth” in an embodiment.

FIG. 5C depicts aggregate fact table generated for the store dimension for the KPI “percentage of sales growth” in an embodiment.

FIG. 6 depicts a sample dashboard presented to high level executives in an embodiment.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

1. Terminology

The terminology below is further illustrated with respect to sales KPI merely for ease of understanding.

Data set: A collection of data points, with each data point representing a fact value (defined below) for a combination of members (defined below). For example, the sale amount (e.g. in USD) of cars sold by a store in a country represents a corresponding fact value for the combination of vehicle, store and country.

KPI: A numerical measure of an aspect of interest generated by analyzing a data set. The aggregate sales represented by the entire data set represents a KPI. A KPI may also be expressed in others forms such as a ratio, proportion or percentage, as is well known in the relevant arts.

Dimension: A qualitative way in which the fact values are organized or presented. In the above example data set, vehicle, store, and country would represent different dimensions. A dimension may also be referred to as “dimensional attribute” as is well known in the relevant arts.

Member: A member is referred in relation to a dimension, and represents one of the categories in that specific dimension. For example, US and UK are members of country dimension. Similarly, cars and trucks are members of vehicle dimension.

Fact value: A fact value is associated with a specific combination of members, and represents a numerical measure for that combination of members.

Fact table: A fact table is a collection of fact values, with each row representing a corresponding fact value.

While the above terminology is used in the context of a data warehouse in the illustrative examples below, it should be appreciated that the terminology is applicable for various other data models in other data sources as well.

2. Overview

An aspect of the present disclosure aids further examination of data sets for improving corresponding key performance indicators (KPIs). In an embodiment, a data set containing a plurality of data points is selected, with each data point specifying an individual fact value for a respective combination of members and each member being associated with a corresponding dimension. A respective aggregate fact value is generated for each member of each dimension. A respective variation among aggregate fact values of corresponding members is computed for each dimension. The set of dimensions having more variation is identified as containing pertinent information for further examination of a KPI.

In an embodiment, such pertinent set of dimensions are identified in a business intelligence (BI) application which operates in combination with a data warehouse. The data set containing the individual fact values are pre-computed for respective combination of members and stored in the data warehouse. In addition, a schema of the data warehouse can be examined to determine the dimensions and the members for each dimension. Accordingly, the pertinent dimension to be further examined can be generated without requiring substantial computation power and also without requiring user input to specify the dimensions (of the underlying data) or members therein.

According to another aspect, a respective dimension for each of several KPIs is similarly identified and the set of such dimensions associated with respective KPIs is displayed on a dashboard conveniently for users such as business executives.

According to another aspect, a set of dimensions is automatically identified as containing pertinent information for further examination of a KPI. The term automatic implies that the user need not provide any specific input for tasks integral to identification of the set of dimensions from the multiple dimensions associated with the KPI. A dashboard may be provided to identify similar sets of dimensions for respective KPIs of interest so that persons such as high level executives may be able to quickly visualize pertinent aspects that are to be further investigated.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

3. Example Environment

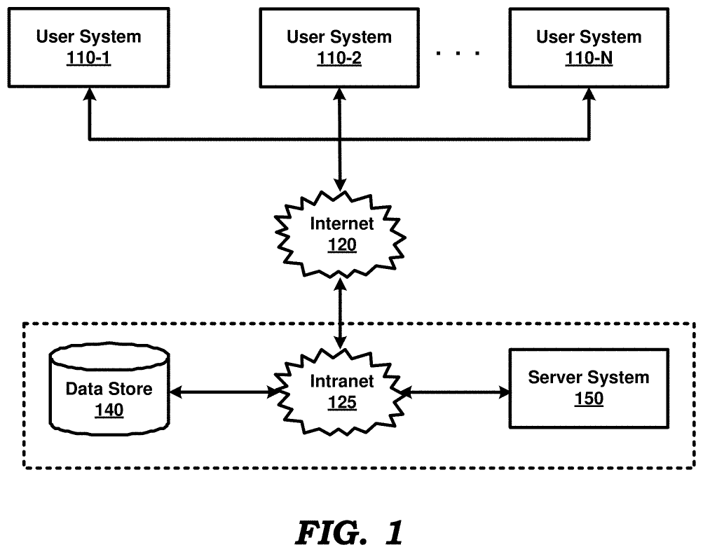

FIG. 1 is a block diagram illustrating an example environment (computing system) in which several aspects of the present disclosure can be implemented. The block diagram is shown containing user systems 110-1 to 110-N, internet 120, intranet 125, server system 150 and data store 140. User systems 110-1 to 110-N are collectively or individually referred by referral numeral 110, as will be clear from the context.

Merely for illustration, only representative number/type of blocks is shown in FIG. 1. Many environments often contain many more blocks, both in number and type, depending on the purpose for which the environment is designed. Specifically, many instances of server system 150 and data store 140 may be present in the computing system. Each block of FIG. 1 is described below in further detail.

Internet 120 represents a data network providing connectivity between user systems 110-1 to 110-N and server system 150. Internet 120 may encompass the world-wide connected Internet. Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by internet 120. When the packet contains content such as port numbers, which specifies an internal component such as target application and/or internal system, the packet may be directed to such application or internal system as well.

Intranet 125 provides connectivity between data store 140 and server system 150. Intranet 125 may be implemented using any combination of wire-based or wireless mediums.

Data store 140 represents a non-volatile (persistent) storage facilitating storage and retrieval of a collection of data sets by server system 150. Data in the data sets may be organized using any combination of relational, hierarchical, network, etc., type models as is well known in the relevant arts.

In an embodiment, data store 140 may represent a data warehouse storing large data sets with the corresponding schema, e.g. star schema, snowflake schema. The data points stored in data store 140 may represent various consolidated fact values for combination of various members, with each consolidated fact value being generated from elemental fact values gathered over a long duration via transactional databases, as is well known in the relevant arts.

Server system 150 represents a server, such as a web/application server, executing one or more software applications such as ERP, CRM, BI applications, etc. Server system 150 may provide suitable interfaces for user systems 110 to access such applications. Many instances of server system 150 and data store 140 may be provided in a cloud infrastructure.

Each of user systems 110-1 to 110-N represents a system such as a personal computer, workstation, mobile device, computing tablet, etc., used by end users. User system 110 may be used by persons such as high level executives for examination of various KPIs of interest. However, as noted above, it is often a challenge to decide which initial direction the investigation may be undertaken.

An aspect of the present disclosure aids further examination of a data set for improving a corresponding KPI as described below with examples.

4. Flowchart

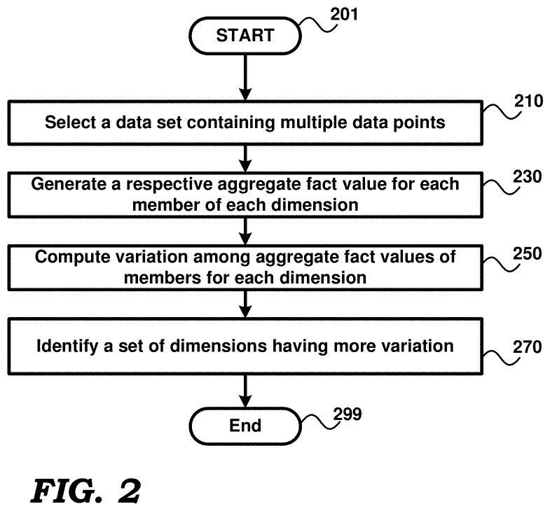

FIG. 2 is a flowchart illustrating the manner in which further examination of a data set is aided according to an aspect of the present disclosure. The flowchart is described with respect to the server system 150 of FIG. 1 merely for illustration. However, many of the features can be implemented in other systems (e.g., user systems 110) and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, server system 150 selects a data set containing multiple data points from data store 140. Each data point in the data set may specify an individual fact value for a respective combination of members. The KPIs corresponding to the selected data set have associated dimensions, with each dimension having respective set of members. It may be appreciated that selection of the data set may entail selection of data points across objects/entities in data store 140. For example, in a relational database, server system 150 may perform joins and computations on multiple tables in order to select the data set.

Alternatively, in data warehousing type of environments, many such joins and computations may be performed a priori to provide consolidated fact values as data points. However, the fact values present in a data warehouse may be further consolidated (e.g., by roll-up operations) to generate the data points of step 210. Irrespective, due to the prior consolidation, the flow chart of FIG. 2 may be realized with minimal computations. Accordingly, in such situations, the flow chart can be implemented in each user system 110 directly without the aid of server system 150 for computations. Control passes to step 230.

In step 230, server system 150 generates a respective aggregate fact value for each member of each dimension. An ‘aggregate fact value’ may refer to data combined from several individual fact values of the data set. An aggregate fact value may be a simple cumulative value (e.g. total sales for each member country) or an average (e.g. average sales for a store) or any other value derived from a mathematical operation based on individual fact values or other aggregate fact values. For a particular KPI, server system 150 may compute aggregate fact value for each member of each dimension associated with the KPI. In data warehousing type of environments, the individual fact values may be rolled up at a member level to get the desired aggregate fact value for that member. Control passes to step 250.

In step 250, server system 150 computes variation among aggregate fact values of members for each dimension. In step 270, server system 150 identifies a set of dimensions having more variation using the variation values computed in step 250 as warranting further examination for actionable items in respect of the KPI under consideration. Server system 150 may forward the set of dimensions to user system 110 for display. The display indicates that those dimensions can be further examined for actionable items.

Such set of dimensions are determined to be of interest based on an observation that more variation among aggregate fact values of members in a dimension generally indicates that further examination is warranted (from the perspective of that dimension) by high level executives as end users.

However, given that the values for each member can be in broad different ranges and also the number of members in each dimension may vary significantly, for the comparison to be meaningful, it may be desirable to normalize the compared values based on the range of values for that member. An example approach to such normalization is described in embodiments below in which a “total sales” KPI is associated with three dimensions—country, store and product.

5. Dimension and Fact Tables

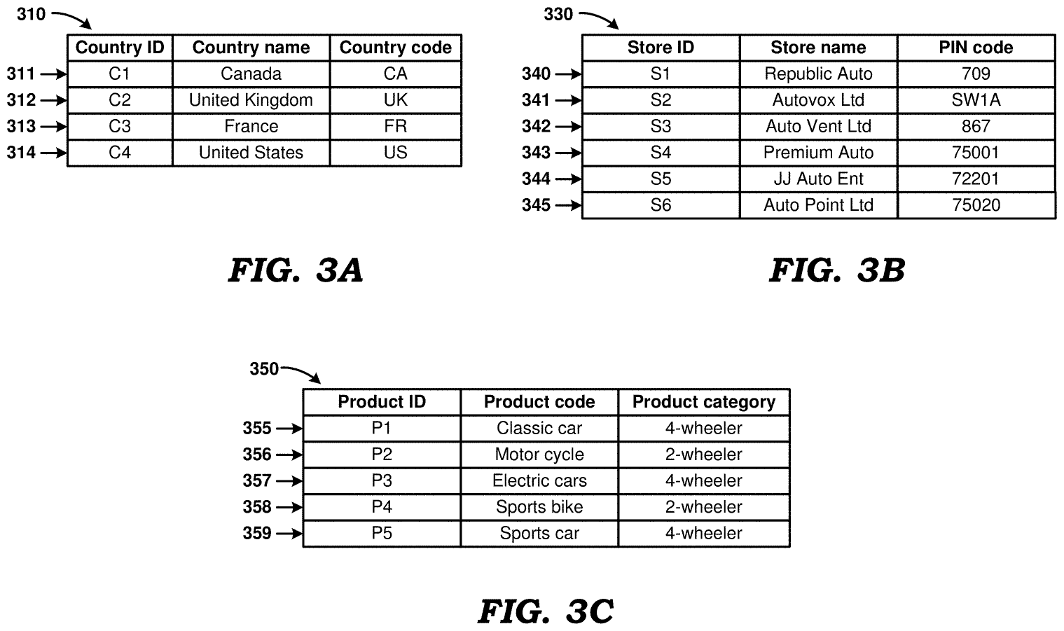

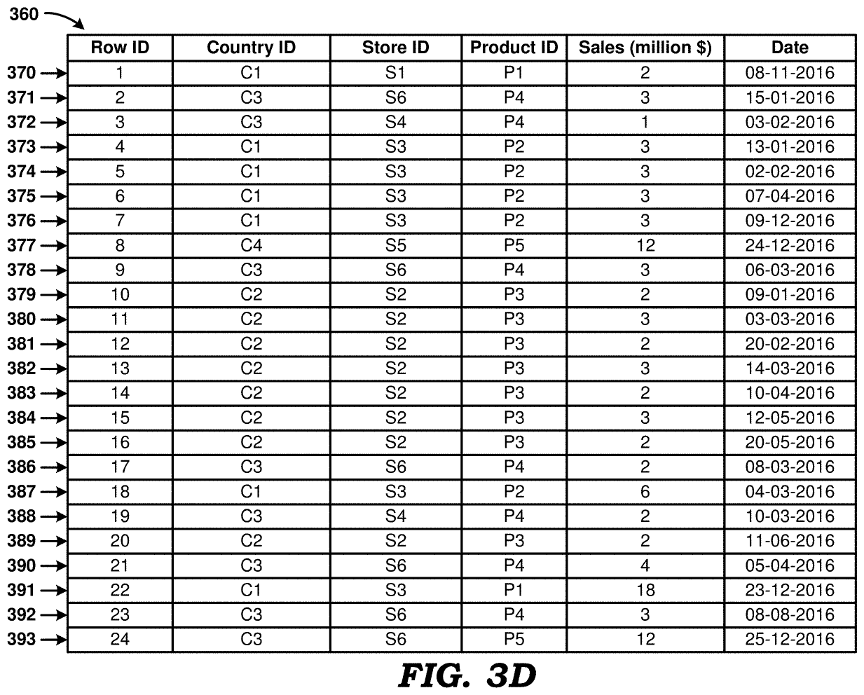

FIGS. 3A-3C depict sample dimension tables in data store 140 in the form of a data warehouse (having consolidated fact values as data points) implemented using warehouse schema. Only some of the fields of the dimension tables, as relevant to an understanding of the disclosure, are depicted in the Figure for conciseness. Also, data store 140 may contain many more tables and many more rows as will also be apparent to persons skilled in the art. Although the illustration is described with respect to analyzing dimensions of a KPI with respect to a time grain of a year, it may be appreciated that dimensions of a KPI may be analyzed with respect to any desired time grain such as month, quarter, etc.

FIG. 3A depicts country dimension table 310 and is shown containing 4 rows [311-314]. Column “Country ID” specifies the unique identifier for a country. Columns “Country name” and “Country code” specify the name and two-letter ISO code of the country respectively.

FIG. 3B depicts store dimension table 330 and is shown containing 6 rows [340-345]. Column “Store ID” specifies the unique identifier for a store. Columns “Store name” and “PIN code” specify the name and zip code of the store respectively.

FIG. 3C depicts product dimension table 350 and is shown containing 5 rows [355-359]. Column “Product ID” specifies the unique identifier for a product. Columns “Product code” and “Product category” specify the product business code and category of the product respectively.

FIG. 3D depicts sample fact table representing sales data for the year 2016. Sales fact table 360 is shown containing 24 rows [370-393]. Column “Row ID” specifies the unique identifier for an individual fact value. Column “Country ID”, “Store ID” and “Product ID” specify the respective unique identifiers of the country, store and product for the corresponding sale. Column “Sales” specifies the sale amount in million USD. Column “Date” specifies the date of sale. Thus, row 370 depicts a sale amount (individual fact value) for a combination of members—“Canada” (C1), “Republic Auto” (S1) and “Classic Car” (P1). Each member of the fact value is associated with a corresponding dimension; e.g. “Canada” is associated with the country dimension.

The description is continued with respect to the manner in which server system 150 generates aggregate fact values or rolled up data from individual fact values as part of computing variation, in accordance with features of the present disclosure.

6. Generating Aggregate Fact Values

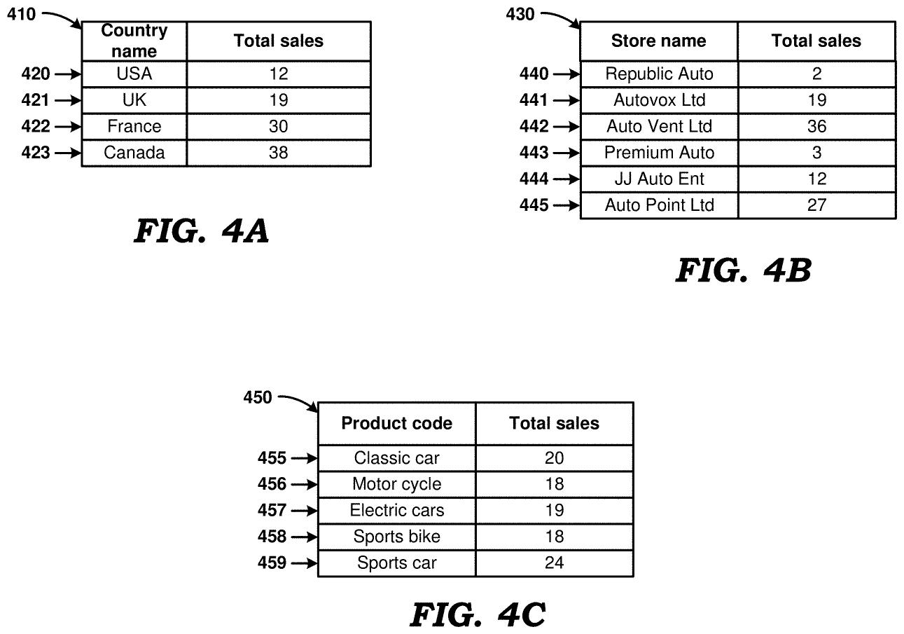

FIGS. 4A-4C depict the aggregate fact values generated by server system 150 for each member of each dimension. Each row in the corresponding table represents an aggregate fact value for a particular member of the dimension. Although descriptive attributes of members (e.g. country name) have been depicted in the columns for convenience, it may be appreciated that the aggregate fact values may be stored against the corresponding unique identifier of the member (e.g. country ID) as will be apparent to a skilled practitioner.

FIG. 4A depicts the aggregate fact values for members of “Country” dimension. Specifically, table 410 is shown containing rows 420-423. Column “Country name” specifies the country name (as listed in table 310 for the respective country) and column “Total sales” depicts the total sales in million USD for each country.

FIG. 4B depicts the aggregate fact values for members of “Store” dimension. Specifically, table 430 is shown containing rows 440-445. Column “Store name” specifies the store name (as listed in table 330 for the respective store) and column “Total sales” depicts the total sales in million USD for each store.

FIG. 4C depicts the aggregate fact values for members of “Product” dimension. Specifically, table 450 is shown containing rows 455-459. Column “Product code” specifies the product code (as listed in table 350 for the respective product) and column “Total sales” depicts the total sales in million USD for each product.

Server system 150 generates a respective aggregate fact value for each member of each dimension. For example, server system 150 generates aggregate fact value for “Canada” by computing the sum of sales of all rows having country ID C1 (“Canada”) in sales fact table 360 (rows 1, 4-7, 18 and 22, as shown below).

Row 1-2

Row 4-3

Row 5-3

Row 6-3

Row 7-3

Row 18-6

Row 22-18

Server system 150 stores the sum thus generated (38) as the aggregate fact value for the member “Canada” of the dimension “Country” in row 423.

Server system 150 continues in the above manner and generates the aggregate fact values for each member in each dimension, as depicted in tables 410, 430 and 450. These aggregate fact values can be calculated by rolling up the data for each member using grouping statement in a data warehouse.

In an alternative scenario, the aggregate fact values may be pre-computed and stored in data store 140, thus reducing run-time computational complexity. In such scenarios, server system 150 or user system 110 may directly compute variation.

The description is continued with respect to the manner in which server system 150 computes variation in accordance with features of the present disclosure.

7. Identifying Dimensions with More Variation

Server system 150 executes steps 210-270 of flowchart of FIG. 2 to identify dimensions with more variation. Specifically, server system 150 first selects sales fact table 360 as the data set corresponding to “Total sales” KPI. In step 230, server system 150 generates aggregate fact values for each member of each dimension, as shown in tables 410, 430 and 450.

In step 250, server system 150 computes variation for each of the three dimensions—country, store and product for “total sales” KPI for the year 2106.

In an embodiment, the variation is computed based on two quantities—a difference and a normalization value, as described in further detail below. For each dimension, server system 150 computes a difference between the largest aggregate fact value and the smallest aggregate fact value for that dimension, computed in step 230 above. Server system 150 then computes the normalization value as the square root of the sum of the squares of the aggregate fact values of members of that dimension (Euclidean norm or 12 norm), and the variation for each dimension by dividing the difference by the normalization value. As noted above, such normalization lends a meaningful comparison of variation values across different dimensions.

It may be appreciated that the above approach is one of the ways of computing variation. However, alternative ways of computing variations will be apparent to a skilled practitioner without departing from the scope and spirit of several aspects of the present invention, by reading the present disclosure.

Turning now to FIG. 4A, server system 150 identifies row 423 as having the largest aggregate fact value (38) and row 420 as having the smallest aggregate fact value (12) in the country dimension for computing the difference. Server system 150 computes the difference, 38−12=26.

It may be appreciated that server system 150 may first sort the aggregate fact values for a dimension in an ascending order to compute such a difference, thus making the difference independent of the ordering of the aggregate fact values within a dimension.

As a next step, server system 150 computes a normalization value. In the illustrative embodiment, the normalization value is computed as the square root of the sum of the squares of the aggregate fact values of that dimension. Thus, the normalization value for the aggregate fact values in table 410 is:

√(12²+19²+30²+38²)=53.37

Server system 150 computes the variation by dividing the difference by the normalization value.

Thus, variation for country dimension is:

26/53.37=0.48

In this manner, server system 150 computes the variation for the store and product dimensions as well.

Thus, referring to FIG. 4B, variation for store dimension is [36−2]/√(2²+19²+36²+3²+12²+27²)=34/50.42=0.67. Similarly, variation for product dimension is 0.09.

Once server system 150 has computed the variation for each dimension as illustrated above, server system 150 identifies a set of dimensions with more variation for a KPI. For the “total sales” KPI, amongst the dimensions country, store and product with variation values 0.48, 0.67 and 0.09 respectively, it may be observed that store dimension has the most variation, followed by country and product dimensions. Thus, server system 150 identifies store dimension as containing most pertinent information for further examination of “total sales” KPI.

It may be appreciated that a particular dimension is identified as containing pertinent information when the variation for the dimension is more. For example, the high variation value for store dimension may indicate to a business executive that further examination of the sales across stores is required. Upon further examination, it may be observed that while the store “Republic Auto” has made total sales of 2 million USD in year 2016, the store “Auto Vent Ltd” has made total sales of 36 million USD (referring to table 430 in FIG. 4B) during the same year. Assuming that the stores sizes are comparable, the business executive may take corresponding corrective course of action for “Republic Auto” store. Alternatively, or in addition, the sale practices of “Auto Vent Ltd” may be analyzed and adopted throughout the organization for improving the “total sales” KPI.

Server system 150 may repeat the above steps 210-270 of flowchart of FIG. 2 for each KPI in an organization. In this manner, server system 150 operates to aid further examination of a data set for improving a corresponding KPI.

It may be appreciated that each KPI in an organization may potentially have several dimensions. Analyzing a KPI on a dimension-by-dimension basis may be cumbersome and complicated. When a set of dimensions containing pertinent information is presented to the end user, it aids a focused approach of further examination of the relevant data set to improve the corresponding KPI.

The description is continued with respect to a second illustrative example for “percentage of sales growth” KPI.

8. Percentage KPI illustration

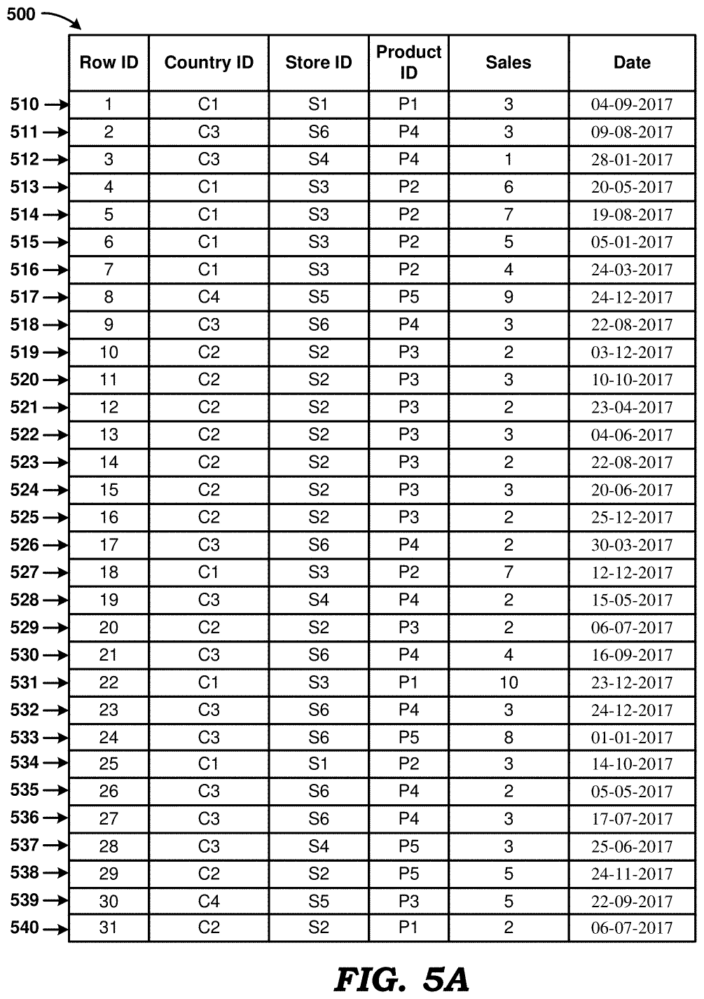

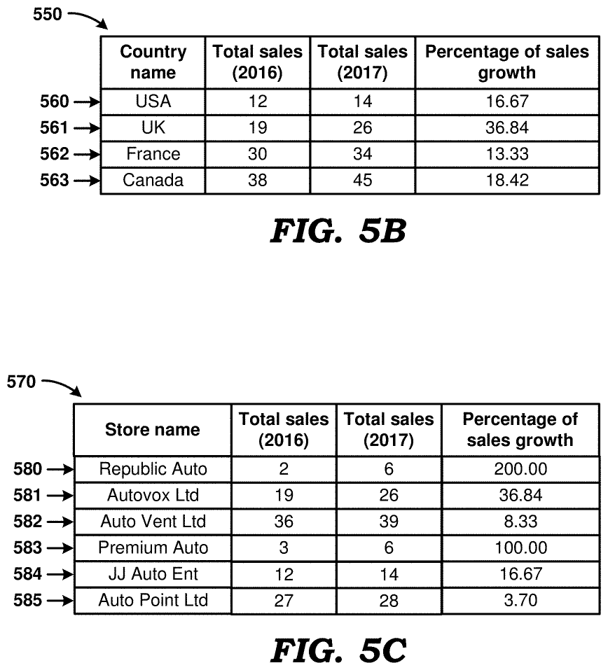

FIG. 5A depicts a second sample fact table representing sales data for the year 2017. Sales fact table 500 is shown containing 31 rows [510-539]. Although sales fact tables 360 and 500 are shown containing annual sales data for convenience, it will be apparent to a skilled practitioner that sales data for all years may be stored in a single fact table. In such a scenario, server system 150 may first select the relevant data set for computing a corresponding KPI.

FIG. 5B depicts the aggregate fact values for members of “Country” dimension. Specifically, table 550 is shown containing rows 560-563. Column “Country name” specifies the country name (as listed in table 310 for the respective country), columns “Total sales (2016)” and “Total sales (2017)” depict the total sales in million USD for each country for year 2016 and year 2017 respectively, and column “Percentage of sales growth” depicts the percentage of growth of sales as compared to the previous year (2016) for each member of the country dimension.

FIG. 5C depicts the aggregate fact values for members of “Store” dimension. Specifically, table 570 is shown containing rows 580-585. Column “Store name” specifies the store name (as listed in table 330 for the respective store), columns “Total sales (2016)” and “Total sales (2017)” depict the total sales in million USD for each store for year 2016 and year 2017 respectively, and column “Percentage of sales growth” depicts the percentage of growth of sales as compared to the previous year (2016) for each member of the store dimension.

As described above with respect to the “total sales” KPI, server system 150 selects sales fact tables 360 and 500 as the data set for “percentage of sales growth” KPI. Server system 150 then generates a respective aggregate fact value for each member of each dimension.

In this second illustration, the aggregate fact value is the percentage of sales growth. The aggregate fact value is calculated as:

{(Total sales in 2017−Total sales in 2016)/(Total sales in 2016)}*100.

Total sales for each year is computed as illustrated above with respect to “total sales” KPI.

For example, for country “Canada” [row 563], percentage sales growth is calculated as:

(45−38)/38*100=18.42%

Server system 150 then computes the variation for country and store dimensions based on difference and normalization values, as described above in great detail. From the aggregate fact values in tables 550 and 570, the variation for country and store dimensions is computed as 0.50 and 0.86 respectively.

Thus, server system 150 identifies store dimension as the one containing most pertinent information for the “percentage of sales growth” KPI.

The high variation value for store dimension may indicate to a business executive that further examination of the percentage of sales growth across stores is required. Upon further examination of the corresponding data set, it may be observed that the store “Republic Auto” has a 200% increase in sales in 2017 as compared to 2016 whereas the store “Auto Vent Ltd” has a mere 3.70% increase in sales for the same period.

In this illustration, it is assumed that “Republic Auto” is a small store compared to “Auto Vent Ltd”. As can be observed from the above, the increase in total sales from year 2016 to 2017 is 4 million USD for “Republic Auto” and 3 million USD for “Auto Vent Ltd”. However, the percentage increase is 200% for “Republic Auto” and only 3.70% for “Auto Vent Ltd”.

Thus, a further examination of the data set reveals that “Republic Auto” has performed well compared to “Auto Vent Ltd”, although the absolute value of increase in sales is almost equal.

It may be appreciated that percentage calculation (as described above) may be simplified in a data warehousing type of environment with in-built data warehouse functions, as is well known in the relevant arts. It may also be appreciated that if an aggregate fact value is represented in the form of a ratio or percent, the results based on computation of variation would be more intuitive as the context of the corresponding fact value is also accounted for.

Thus, server system 150 may determine the pertinent dimension of interest for each relevant KPI, and all such dimensions may be suitably communicated via a dashboard for convenient viewing by a high level executive as described below.

9. Sample BI dashboard

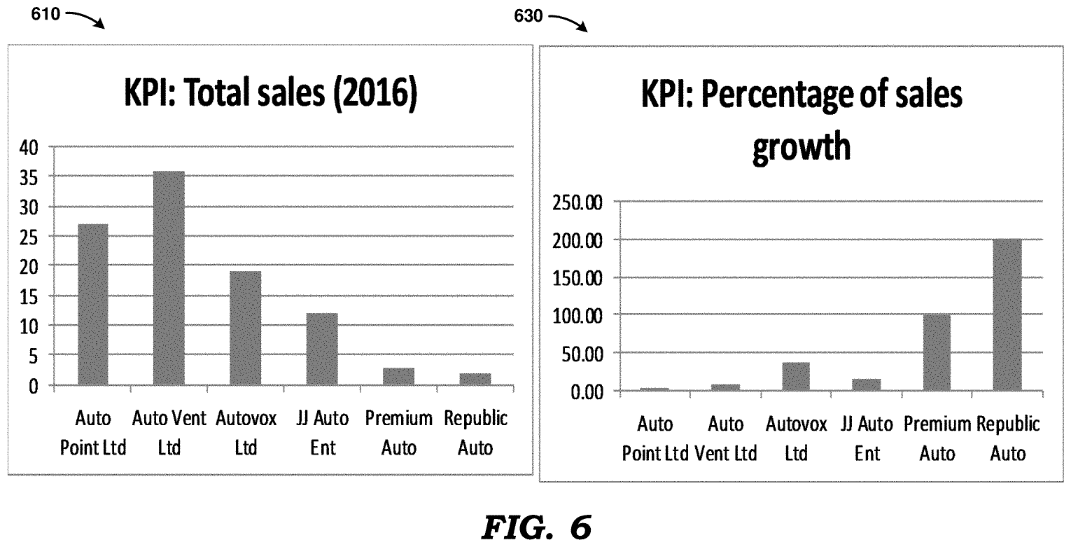

FIG. 6 depicts a sample dashboard displayed by server system 150 on user system 110. The respective dimensions of interest for each KPI are shown communicated by a graph depicting the aggregate fact values computed for the respective dimensions. Accordingly, an intuitive user interface is quickly provided for users.

The dashboard of FIG. 6 is shown containing two bar graphs, one each for the “total sales” KPI and the “percentage of sales growth” KPI. Bar graph 610 is shown containing data associated with the store dimension (table 430) as the store dimension was identified as the most pertinent dimension for the “total sales” KPI. Similarly, bar graph 630 is also shown containing data associated with the store dimension (table 570) as the store dimension was identified as the most pertinent dimension for the “percentage of sales growth” KPI. It may be appreciated that high level executives may be able to quickly visualize pertinent aspects that are to be further investigated by viewing bar graphs 610 and 630.

As noted above, data store 140 may be implemented as a data warehouse. In such scenarios, the data set containing the individual fact values may be pre-computed for respective combination of members and stored in the data warehouse, thus reducing run-time computational complexity.

In addition, a schema of the data warehouse may be examined to determine the dimensions and the members for each dimension. In other words, the user is not required to provide any inputs in this respect (i.e., to indicate any of the dimensions of interest for any given KPI) and still conveniently and automatically view the dimensions of relevance for different KPIs. In other words, the user may not need to indicate any of the dimensions of interest, and instead features of the present disclosure operate to identify all of dimensions of interest by examining the schema (or similar input that shows all the dimensions of the schema).

Similarly, though the description of above is provided with respect to year as the duration, it should be understood duration of any other grain (e.g., months, days, quarters, etc.) can be used instead.

In addition, it may be appreciated that the features of the disclosure can be operative in conjunction with (specifically as a follow-up to) approaches which automatically determine KPIs of interest (for example, as described in the RELATED APPLICATION noted above), and the dimensions of interest can then be determined for each of such KPIs in accordance with the features of the present disclosure. Accordingly, both KPIs of interest and the relevant dimensions in each KPI may be automatically determined and made available in a dashboard according to aspects of the present disclosure.

It should be appreciated that the features described above can be implemented in various embodiments as a desired combination of one or more of hardware, software, and firmware. The description is continued with respect to an embodiment in which various features are operative when the software instructions described above are executed.

10. Digital Processing System

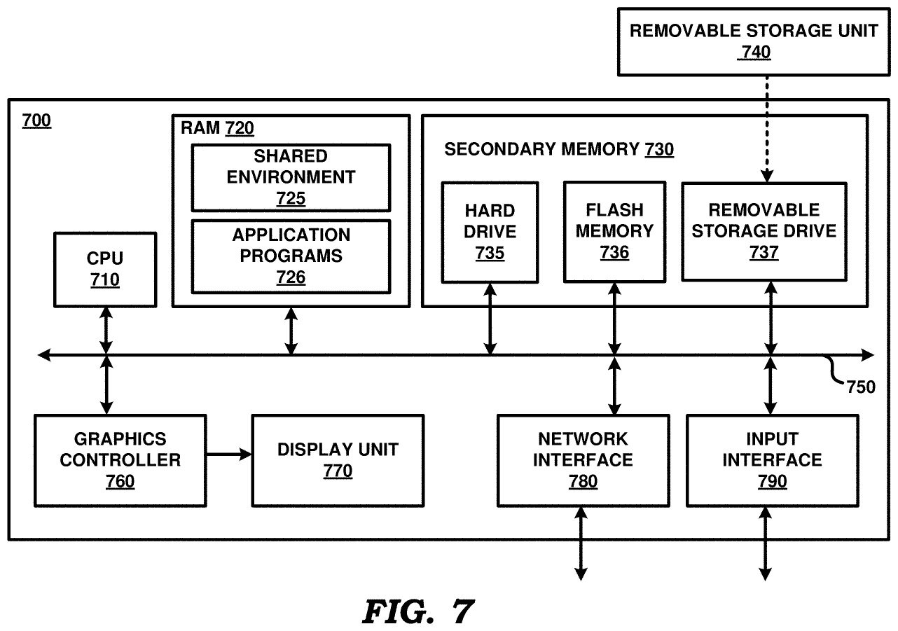

FIG. 7 is a block diagram illustrating the details of digital processing system 700 in which various aspects of the present disclosure are operative by execution of appropriate executable modules. Digital processing system 700 may correspond to one of user system 110 or server system 150.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726. Shared environment 725 contains software programs such as device drivers, operating systems, virtual machines, containers, etc., which provide a (shared) run time environment for execution of other/user programs.

Graphics controller 760 generates display signals (e.g., in RGB format) to display unit 770 based on data/instructions received from CPU 710. Display unit 770 contains a display screen to display the images (e.g., dashboard of FIG. 6) defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with data store 140 (of FIG. 1) connected to the networks (120).

Secondary memory 730 may contain hard drive 735, flash memory 736, and removable storage drive 737. Secondary memory 730 may store the data (for example, data portions shown in FIGS. 3A-3D) and software instructions (for example, for implementing the various features of the present disclosure as shown in FIG. 2, etc.), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

10. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method comprising:
selecting a data set containing a plurality of data points, each data point specifying an individual fact value for a respective combination of members, each member being associated with a corresponding dimension of a plurality of dimensions;
generating a respective aggregate fact value for each member of the respective combination of members of each dimension of said plurality of dimensions;
computing variation among aggregate fact values of members for each dimension; and
identifying a set of dimensions having more variation as containing pertinent information for further examination of a key performance indicator (KPI) which is based on said data set.

2. The method of claim 1, wherein said variation for each dimension is based on a difference between the largest aggregate fact value and the smallest aggregate fact value in that dimension.

3. The method of claim 2, wherein said variation is computed by dividing the difference by a normalization value, wherein the normalization value is the square root of the sum of the squares of the aggregate fact values of that dimension.

4. The method of claim 3, wherein said identifying comprises:
sorting the plurality of dimensions based on the respective variations; and
picking the dimension with the highest variation as containing most pertinent information for further examination of the KPI.

5. The method of claim 2, wherein said method is performed in a business intelligence (BI) application, operating in conjunction with a data warehouse comprising a schema specifying said plurality of dimensions for said plurality of data points, said method further comprising:
examining said schema to determine said plurality of dimensions and said members for each dimension, whereby said set of dimensions are identified without requiring user input to specify said plurality of dimensions or members therein.

6. The method of claim 5, further comprising repeating for each KPI of a plurality of KPIs said selecting, said generating, said computing and said identifying to identify a respective dimension for each KPI, said method further comprising:
displaying all of said respective dimensions on a dashboard for viewing by a user.

7. The method of claim 6, wherein said KPI is related to sales information.

8. A non-transitory machine readable medium storing one or more sequences of instructions, wherein execution of said one or more instructions by one or more processors contained in a digital processing system enables the digital processing system to perform the actions of:
selecting a data set containing a plurality of data points, each data point specifying an individual fact value for a respective combination of members, each member being associated with a corresponding dimension of a plurality of dimensions; and
analyzing said data set to identify a set of dimensions of said plurality of dimensions as containing pertinent information for further examination of a key performance indicator (KPI) which is based on said data set, wherein said set of dimensions is identified without requiring user inputs to specify any of said plurality of dimensions.

9. The non-transitory machine readable medium of claim 8, wherein said analyzing comprises:
generating a respective aggregate fact value for each member of the respective combination of members of each dimension of said plurality of dimensions;
computing variation among aggregate fact values of members for each dimension; and
identifying as said set of dimensions those of said plurality of dimensions having more variation.

10. The non-transitory machine readable medium of claim 9, wherein said variation for each dimension is based on a difference between the largest aggregate fact value and the smallest aggregate fact value in that dimension.

11. The non-transitory machine readable medium of claim 9, wherein said variation is computed by dividing the difference by a normalization value, wherein the normalization value is the square root of the sum of the squares of the aggregate fact values of that dimension.

12. The non-transitory machine readable medium of claim 11, wherein said identifying comprises:
sorting the plurality of dimensions based on the respective variations; and
picking the dimension with the highest variation as containing most pertinent information for further examination of the KPI.

13. The non-transitory machine readable medium of claim 10, wherein said method is performed in a business intelligence (BI) application, operating in conjunction with a data warehouse comprising a schema specifying said plurality of dimensions for said plurality of data points, said method further comprising:
examining said schema to determine said plurality of dimensions and said members for each dimension, whereby said set of dimensions are identified without requiring user input to specify said plurality of dimensions or members therein.

14. The non-transitory machine readable medium of claim 13, further comprising repeating for each KPI of a plurality of KPIs said selecting, said examining, said analyzing, and said identifying to identify a respective dimension for each KPI, said method further comprising:
displaying all of said respective dimensions on a dashboard for viewing by a user.

15. A server system comprising:
a random access memory (RAM) to store instructions;
one or more processors to retrieve said instructions and execute said instructions, wherein execution of said instructions causes said server system to perform the actions of:
selecting a data set containing a plurality of data points, each data point specifying an individual fact value for a respective combination of members, each member being associated with a corresponding dimension of a plurality of dimensions; and
analyzing said data set to identify a set of dimensions of said plurality of dimensions as containing pertinent information for further examination of a key performance indicator (KPI) which is based on said data set, wherein said set of dimensions is identified without requiring user inputs to specify any of said plurality of dimensions.

16. The server system of claim 15, wherein said analyzing comprises:
generating a respective aggregate fact value for each member of the respective combination of members of each dimension of said plurality of dimensions;
computing variation among aggregate fact values of members for each dimension; and
identifying as said set of dimensions those of said plurality of dimensions having more variation.

17. The server system of claim 16, wherein said variation for each dimension is based on a difference between the largest aggregate fact value and the smallest aggregate fact value in that dimension.

18. The server system of claim 16, wherein said variation is computed by dividing the difference by a normalization value, wherein the normalization value is the square root of the sum of the squares of the aggregate fact values of that dimension.

19. The server system of claim 18, wherein said identifying comprises:
sorting the plurality of dimensions based on the respective variations; and
picking the dimension with the highest variation as containing most pertinent information for further examination of the KPI.

20. The server system of claim 17, wherein said method is performed in a business intelligence (BI) application, operating in conjunction with a data warehouse comprising a schema specifying said plurality of dimensions for said plurality of data points, said method further comprising:
examining said schema to determine said plurality of dimensions and said members for each dimension, whereby said set of dimensions are identified without requiring user input to specify said plurality of dimensions or members therein; and
repeating for each KPI of a plurality of KPIs said selecting, said examining, said analyzing, and said identifying to identify a respective dimension for each KPI; and
displaying all of said respective dimensions on a dashboard for viewing by a user.
